(19) United States
(12) Patent Application Publication
(10) Pub. No.: US 2003/0004782 A1
(43) Pub. Date: Jan. 2, 2003

(54) Method and apparatus for determining and revealing interpersonal preferences within social groups

(76) Inventor: Miles Adam Kronby, New York City, NY (US)

Correspondence Address: MILES KRONBY, 119 WASHINGTON PLACE, APT. #14, NEW YORK, NY, 10014, US

(21) Appl. No.: 09/892,809

(22) Filed: Jun. 27, 2001

(51) Int. Cl. G06F 17/60

(52) U.S. Cl. 705/10

(57) ABSTRACT

A method and apparatus for automating the process of confidentially determining whether individuals in social groups have positive or negative responses to each other and for automating the process of notifying the people involved of such responses. A computer system receives inputs from participants who have engaged in a group social event indicating the positive and negative responses they have toward each other. The system collects this information and searches for matches, i.e., for mutual positive responses, and for other patterns of response that provide valuable feedback to the participants, such as which participant received the most positive responses overall. The system then reveals this information to all the participants, and allows the participants who matched with each other to communicate privately.

### CROSS-REFERENCE TO RELATED APPLICATIONS

Not applicable.

### BACKGROUND

1. Field of Invention

This application relates to computer software and, specifically, to a method and apparatus for determining and revealing interpersonal attractions and preferences between members of social groups.

2. Description of Prior Art

Although it is becoming more and more common for groups of people to socialize online, such interaction is characterized by an insufficient amount of social feedback.

Although the method in U.S. Pat. No. 5,950,200 to Sudai, et al., Sep. 7, 1999 addresses the detection of reciprocal interests or feelings between individuals, this method doesn't address real-time interaction between groups of people, it is limited both by the fact that its users must know each other outside the context of the matching application, and also by the fact that it reveals a user's feelings “if and only if a match occurs.”

By comparison, this invention offers a far broader range of social feedback to participants in social groups. For example, this invention will provide individuals within social groups answers to such questions as “do the members of the group whom I like feel the same way about me?”, “how many people like me, even if I don't feel the same about them?”, “which members of the group have a mutual attraction to each other?”, and “which members of the group are considered most attractive by other members of the group?”

This feedback is something that many people would love to get at an online or real-world social event, but which has previously been unavailable.

Furthermore, this invention has several significant advantages over online chat rooms. Regular chat rooms, which lack a mechanism for determining and revealing social preferences between members of the group, are often characterized by a lack of focus and purpose. People drift in and out of regular chat rooms, with no particular reason to stay.

By comparison, a chat room employing this invention offers a compelling reason for users to stick around: i.e. they get to find out how members of the group feel about each other. As a result, this invention will offer a considerable increase in “stickiness” (i.e. the ability to attract users frequently and retain them for as long as possible) compared to existing online social environments. This increased stickiness will have significant value to marketers who want to interact with users for as long as possible.

### SUMMARY

This invention allows an individual to receive valuable social feedback by discovering whether members of a social group are responding positively or negatively toward him or her, and toward each other.

### OBJECTS AND ADVANTAGES

Accordingly, several objects and advantages of my invention are:

(a) to provide an application that allows an individual engaged in group socializing to discover whether members of the group are responding positively or negatively toward him or her;

(b) to provide an application that allows individuals engaged in group socializing to discover whether members of the group are responding positively or negatively toward each other;

(c) to provide an application that allows individuals engaged in group socializing to discover the positive and negative responses described above, organized by demographic criteria such as age, gender, and geographical location;

(d) to provide an application that allows individuals engaged in group socializing to discover the positive and negative responses described above, with or without revealing their real identities.

### DESCRIPTION OF DRAWINGS

The accompanying drawings, which are incorporated in and constitute a part of this specification, illustrate several embodiments of the invention and, together with the description, serve to explain the principles of the invention.

FIG. 1 is a block diagram of a computer system in accordance with a preferred embodiment of the present invention.

FIG. 2 is a flow chart showing steps performed in accordance with a preferred embodiment of the present invention to register a new user in the system.

FIG. 3 is a flow chart showing steps performed to allow human users to submit positive or negative votes toward other participants in the social event (this step is called a “match round”), then for all participants to see the results of the votes (this step is called “match results”), and then for participants who submitted mutually positive votes for each other to communicate privately if they choose to do so.

FIG. 4 is a flow chart showing steps to determine the results of the votes submitted during a match round, and then to reveal the results of these votes in the match results.

FIG. 5 is an exemplary format of a database used in conjunction with a preferred embodiment of the present invention.

FIG. 6(a) shows an example of a screen shot of an online social event.

FIG. 6(b) shows an example of a screen shot of a form that allows a user to register positive or negative responses to other participants.

FIG. 6(c) shows an example of a screen shot of the results of these votes.

FIG. 7 is a block diagram showing an example of the present invention implemented using the World Wide Web.

### DESCRIPTION OF INVENTION

Reference will now be made in detail to the preferred embodiments of the invention, examples of which are illustrated in the accompanying drawings. Wherever possible, the same reference numbers will be used throughout the drawings to refer to the same or like parts.

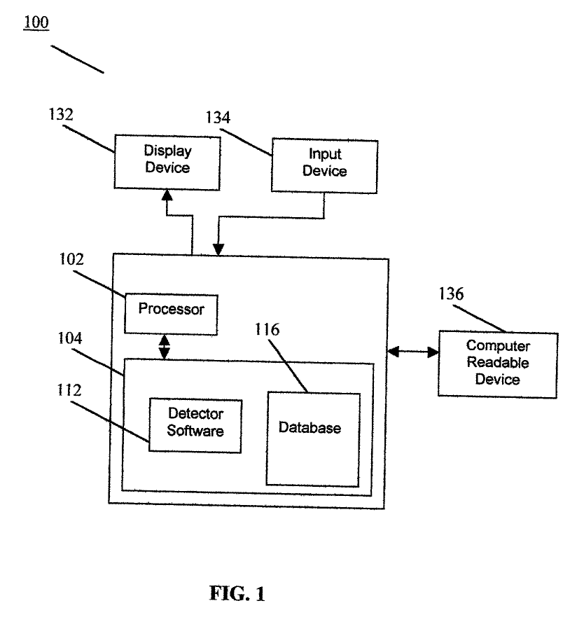

FIG. 1 is a block diagram of a computer system 100 in accordance with a preferred embodiment of the present invention. Computer system 100 includes a processor 102 and a memory 104. Memory 104 includes detector software 112 and a database 116. Database 116 contains information relating to “match votes” (i.e. positive or negative selections by one human being toward another human being in the same group). System 100 preferably connects to a display device 132, such as a display screen, and to an input device 134, such as a mouse or touchpad. Computer system 100 also includes a computer readable device 136, such as a disk drive or CD ROM device. Detector software 112 is preferably loaded into memory 104 via device 136.

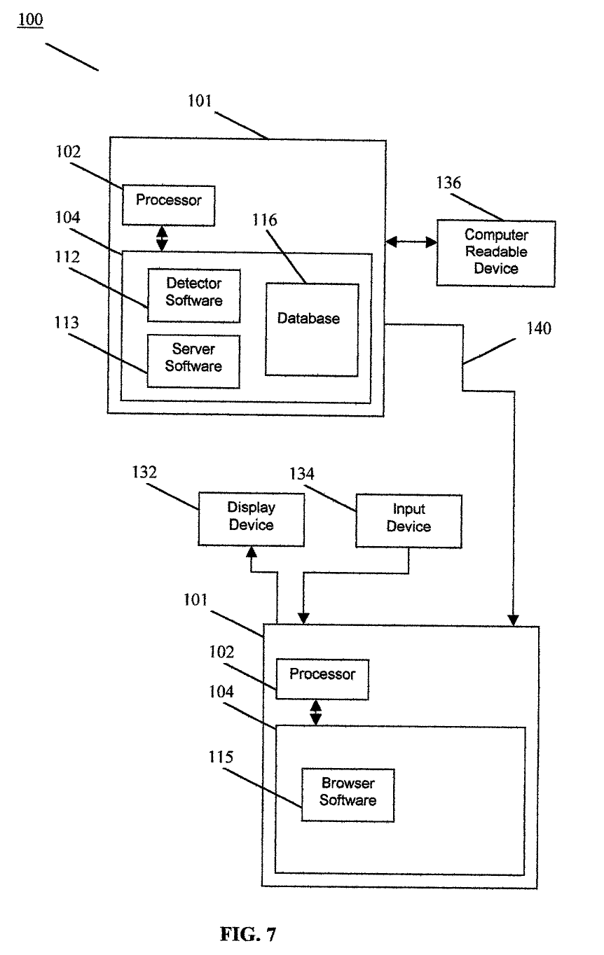

Computer system 100 is preferably connected to a network, such as the Internet or an intranet via a connection 140, shown in FIG. 7. Computer system 100 includes appropriate software to enable computer system 100 to communicate with other computer systems over connection 140.

In other embodiments, various functions of detector software 112 may be distributed in various computer systems of the network. An example of a World Wide Web implementation of detector software 112 is shown in FIG. 7, which is discussed below. It will be understood by persons of ordinary skill in the art that computer system 100 can include additional processors, memory, network connections, I/O devices, software, etc. that are not shown in the Figures for the sake of clarity of example. The present invention can be implemented on a wide variety of hardware, including those shown in FIGS. 1 and 7, or other suitable hardware configurations, such as network computers (NCs), portable wireless devices, and systems that bring the World Wide Web to TV.

In an alternate preferred embodiment (not shown), computer system 100 includes an interactive telephone input system (not shown) that allows the user to input to detector software 112 using the keys on a touchtone telephone or a similar device.

The present invention allows an individual to find out whether members of a social group are responding positively or negatively toward him or her, and toward each other. The invention allows an individual to participate in a social event such as an online group chat, and subsequently to vote on which members of the group he or she has a positive or negative response toward (again, this voting step is called a “match round”), and subsequently to see how other members of the group voted for him or her, and for each other (again, the steps in which votes are revealed is called the “match results”). The term “positive or negative response” includes responses such as attraction, dislike, agreement, disagreement, or other responses that an individual might have toward other members of a social or a professional group. An example of a professional group would be office colleagues who want to determine how each other are thinking about a particular work issue, without revealing their true identities so as not to influence each other by introducing real-world relationships into the discussion.

In other embodiments, various functions of detector software 112 may be a part of the Web, an online service such as America Online or part of an interactive telephone system. Thus, the software 112 may be distributed in various computer systems of the network.

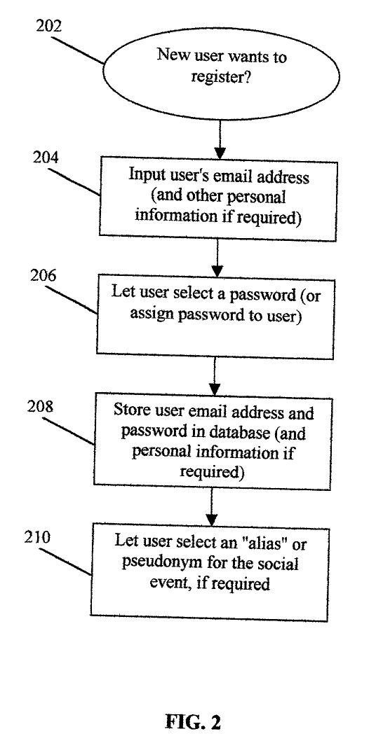

FIGS. 2-4 are flow charts showing steps performed in accordance with the present invention. The steps of FIGS. 2-4 are performed by processor 102 and preferably are implemented as computer instructions of software 112 executed by processor 102. Each of these flow charts is discussed below in turn.

FIG. 2 is a flow chart showing steps performed in accordance with a preferred embodiment of the present invention to register a new user in the system. The registration operation is generally, but not always, performed. Registration lessens the possibility that people are logging on under false names and increases the security of the system. If, however, the system has only a small number of trusted users, all of whom are known to the system, then it might not be as necessary to register the users.

In step 202, the detector software determines that a new user wants to register with the system. In step 204, detector software prompts the user to enter his or her email address, along with personal information such as gender and age. In step 206, the user selects a password. Step 208 stores the user's email address and password (and other personal information) in memory 104. If a particular implementation of the invention includes a registration procedure, the user will be required to enter his or her password before he or she is able to participate in social events within this application in the future. Use of a password makes it less likely that people will log on under a false identity and pretend to have a true identity other than their own. Other ways to authenticate user identity include the use of public/private keys, digital signatures, or biometrics, such as fingerprint or retinal scans. In general, any appropriate method can be used to authenticate users.

In step 210, the user chooses an alias (i.e. a pseudonym) to use in the social event. In some embodiments, users will be identified in the social event by their real names, rather than by their aliases.

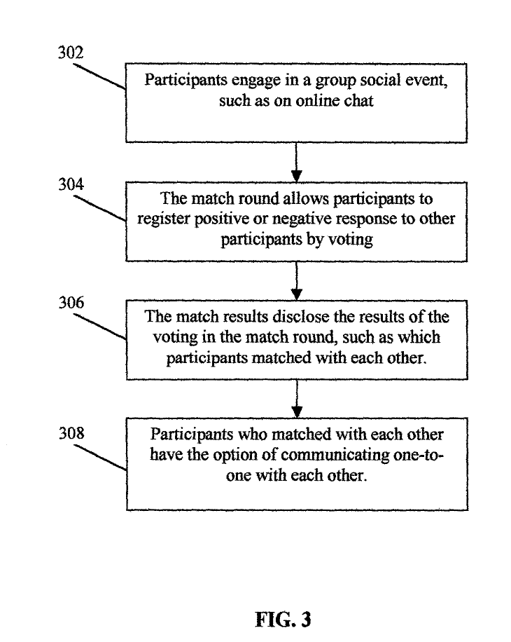

FIG. 3 is a flow chart showing steps performed to allow a human user first to participate in a group social event 302, then to vote in the match round 304, then to see the results of the match round votes 306, then to establish private communication with certain other participants 308.

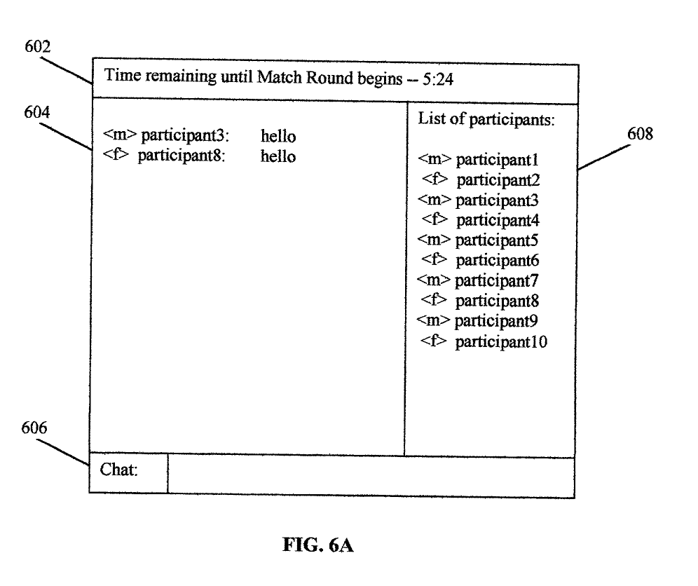

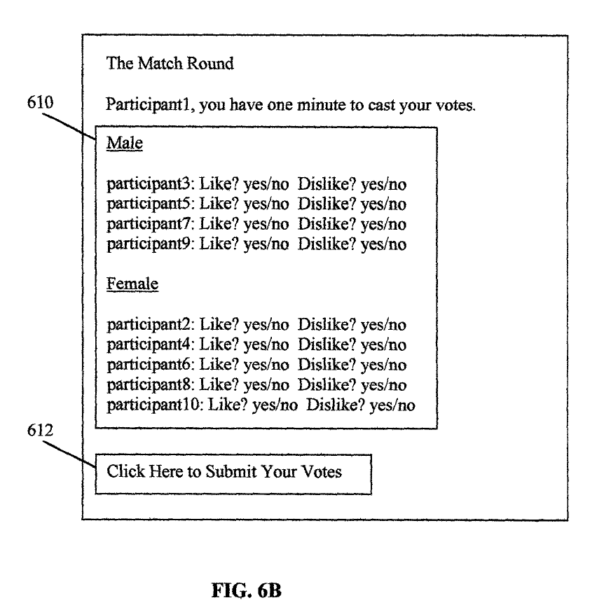

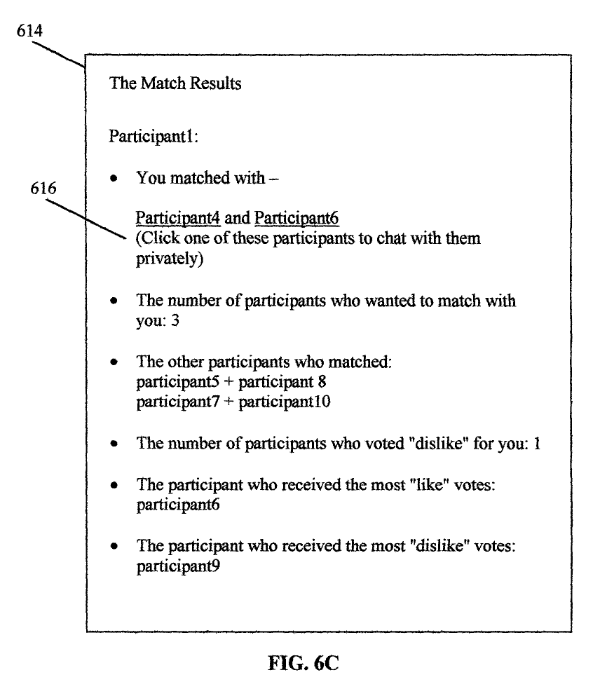

In step 302, all members of the group participate in a social event such as an online chat. During this social event, participants will be identified by the alias or pseudonym they selected before entering the social event, or by their real names or some other ID. During this social event, participants may also be identified by the personal information they entered, such as gender. FIG. 6(a) shows an example of how step 302 would appear on a computer screen.

In step 304, after the social event ends, the match round begins. During the match round, each participant is allowed to vote on each other participant, by recording positive and negative responses such as “like,” “dislike,” “agreement,” and “disagreement” toward any of the other participants. During the match round, participants are identified by the same alias or name and the same personal information that was used during the social event. When a participant (call her “Jane,” for the purpose of this explanation) votes in the match round, her vote remains confidential; other participants learn that this vote came from Jane only in the event that this vote resulted in a match between Jane and another participant. FIG. 6(b) shows an example of how step 304 would appear on a computer screen.

In step 306, the results of the match round votes are revealed to the participants. For a participant (Jane, for example), the match results may include the following information. First, the match results may disclose to Jane which other participants matched with her. A match occurs in the case of mutual attraction, i.e. if Jane votes that she “likes” a participant who votes that he or she “likes” Jane. The match results may also disclose the following: the number of participants who attempted to match with Jane (i.e. the number of participants who voted that they liked Jane, but who Jane did not reciprocally vote for), the aliases of participants who matched with each other, the alias of the participant who received the most positive votes (i.e. the participant who most other participants wanted to match with), and the alias of the participant who received the most negative votes. FIG. 6(c) shows an example of how step 306 would appear on a computer screen.

The present invention may be implemented using any appropriate types of responses or voting criteria in the match round, and subsequent results in the match results.

In step 308, the participants who matched with each other have the option of communicating with each other directly, for example by exchanging e-mail addresses with each other to communicate outside this invention, or by entering a private conversation (e.g. through online chat or voice conversation) within this invention.

FIG. 6(a) shows an example of a computer screen of a group social event, FIG. 6(b) shows an example of a computer screen of a match round, FIG. 6(c) shows an example of a computer screen of match results. These examples show a “Web application” displayed on display device 132 by browser 115 of FIG. 7. This can be implemented using HTML, Java, or any other suitable method. As discussed above, any appropriate technology can be used to implement the present invention.

In FIG. 6(a), area 602 shows the time remaining in the social event before the match round begins. In the preferred embodiment of this invention, this timer counts down every second until it reaches zero. Area 604 shows the ongoing communication between participants, illustrated here as online chat. In area 604, the user's typed communication appears to the right of her alias, and the user's gender (e.g. “<f>”) is indicated to the left of her alias. Area 606 is the input box in which a user can type her communication which will then appear in area 604 (again, this illustration uses online chat as the form of communication, but other forms of communication such as voice chat would also be possible). Area 608 contains a list of aliases of all participants in a social event, with their gender indicated by “<m>” or “<f>.” This social event ends when the timer reaches zero, and then a match round begins.

FIG. 6(b) illustrates the “Web form” that appears in a match round. Area 610 shows a list of aliases of all participants, divided by gender, with voting choices beside each participant. For example, the voting choices illustrated here allow a user such as Participant1 to register his “like” or “dislike” for each of the other participants. A button, 612, allows the user to submit his or her votes. After users have a chance to submit their votes, the match results as shown in FIG. 6(c) appear.

Note that the voting criteria illustrated here, “like” and “dislike,” are just one example of any number of possible voting criteria. In other embodiments, participants could vote on criteria such as, for example, “most witty,” or “most persuasive.”

FIG. 6(c) illustrates the match results. Area 614 contains an example of match results personalized for each user, in this case Participant1. Area 616 contains instructions that let the user enter a private communication with the participants with whom he or she has matched. This private communication (not shown) could take place through online chat, instant messaging, voice communication, or any other appropriate medium.

Although this illustration shows an example of certain match results, different embodiments of the invention would show other kinds of match results. For example, one embodiment could reveal “negative matches”, i.e. which pairs of users mutually registered “dislike” for each other.

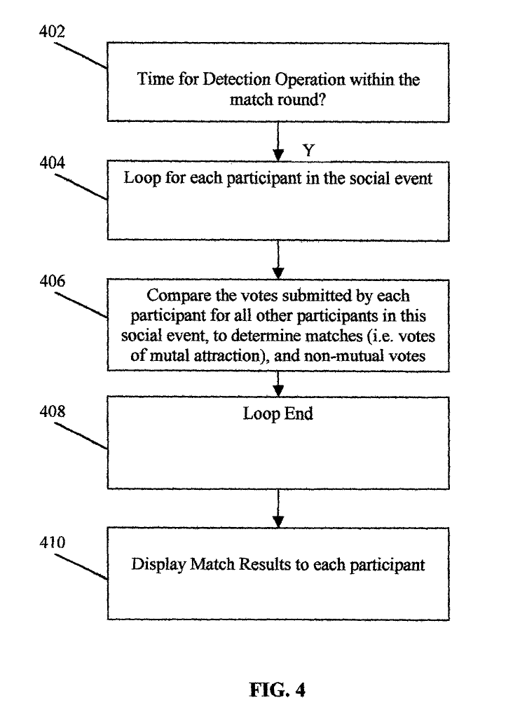

FIG. 4 is a flow chart showing steps to sort the votes that were entered by participants in the match round. Detector software 112 performs the steps of FIG. 4 after all participants have been allowed to enter votes.

Steps 404 through 408 represent a loop performed for each participant in the social event. The record for each participant is stored in the database.

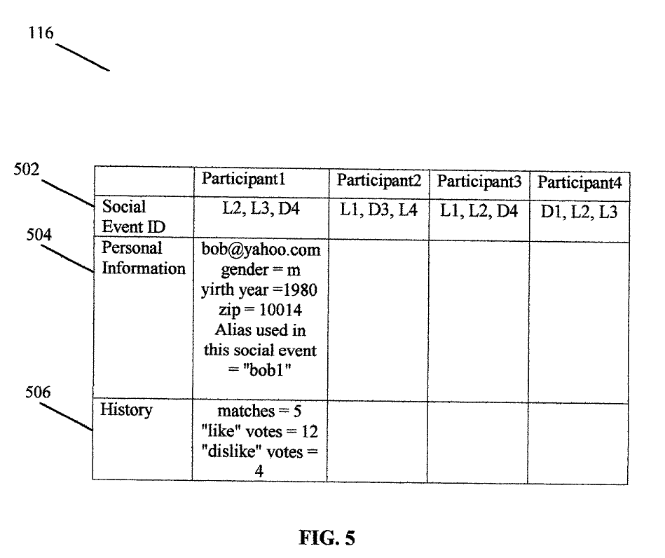

FIG. 5 shows an exemplary format of a database used in conjunction with the described embodiment. It will be understood that the format shown is provided only for the purposes of example and that any appropriate database and database format can be used to implement the present invention. Database 116 contains records for each participant registered in the system. FIG. 5 illustrates three types of records for each participant: how that participant voted during a particular social event 502, the participant's personal information 504, and the history of that participant's use of this invention 506.

Area 502 shows how a participant voted during a particular social event. Each social event, such as a particular instance of an online chat, has a unique ID to distinguish it from all other social events that occur at other times within this invention. Area 502 illustrates a sample vote of four participants in the same social event. Participant1, for example, registered “like” votes for Participant2 and Participant3 (e.g. “L2” and “L3”) and a “dislike” vote for Participant4 (e.g. “D4”).

Therefore, in this example, step 406 in FIG. 4 would determine that, among other results, Participant1 matched with Participant2 (because Participant2 registered a like vote for Participant1), and Participant2 matched with Participant4, and Participant2 received the most “like” votes (a total of three), and Participant4 received the most “dislike” votes (a total of two).

Area 504 shows records of each participants personal information, such as email address, gender, year of birth, zip code, and the alias used by each participant in a given social event. This personal information is revealed at different points in the application. For example, each participant's gender accompanies his or her alias during the social event, as illustrated in FIG. 6(a), areas 604 and 608.

Area 506 shows records of the history of each participant's participation in this invention, such as the total number of times each participant has matched, the total number of “like” votes cast for each participant, and the total number of “dislike” votes cast for each participant. This information allows the application to keep track of, for example, “most popular users overall,” which would be determined by which participants have received the most “like” votes in total.

### CONCLUSION, RAMIFICATIONS, AND SCOPE OF INVENTION

Thus the reader will see that the method and apparatus of the invention provides highly valuable social feedback to participants in group events. The feedback is provided in real-time, immediately after the social event ends, and the feedback remains confidential because participants have the option of concealing their true identities. This feedback could not practically be obtained through any other medium.

While my above description contains many specificities, these should not be construed as limitations on the scope of the invention, but rather as an exemplification of one preferred embodiment thereof. Many other variations are possible. For example,

The social event could occur online, for example through online chat, or it could occur in a physical space in the real world. If the social event occurred in a physical space, participants would access the invention for the match round and the match results, but not for the social event itself.

The match round and match results could occur at various points during the social event, rather than after the social event. This could provide valuable feedback to participants and give them a chance to affect the responses of other participants before the social event ends.

An alternate embodiment could be implemented for a “private label,” such as specifically for users belonging to a club, a company, a school, restaurant, bar, or another entity. Other implementations would only match club or group members with other club or group members.

Alternate embodiments involve different ways for users to participate in social events. In one embodiment, participants join public social events, for example, by coming to the Web site independently. In another embodiment, participants join private social events to which they have received invitations, for example through e-mail.

Alternate embodiments of the present invention implement “rules” included, for example, in software 112, such as: a person can vote that he or she “likes” only one other participant in each social event. Such rules are implemented as computer instructions executed when the user is entering his or her votes in step 304.

In addition, detector software 112 can include sub-sections which would work independently and which would be defined by one or more of the following: the geographic location (e.g., a subsystem that matches only users in the New York area), and the type of user (e.g., a sub-system that would only match high school students with high school students, university students with university students, club members with club members, etc.).

Accordingly, the scope of the invention should be determined not by the embodiment(s) illustrated, but by the appended claims and their legal equivalents.

I claim:

1. A method that allows members of a group to discover how they feel about each other, comprising the steps, performed by a processor of a data processing system having a memory, of:
receiving input from participants indicating their feelings toward each other;
determining which of said participants indicated mutual feelings toward each other;
notifying the group about which of said participants indicated mutual feelings toward each other;
notifying the group about non-mutual feelings indicated by said participants toward other said participants;
allowing said participants to indicate said feelings toward each other and receive notification about said feelings without revealing their true identities to each other.

2. The method of claim 1, wherein the group consists of a number of participants greater than two.

3. The method of claim 1, wherein the participants indicate their feelings toward each other by selecting from a list of choices that represent different kinds of feelings.

4. The method of claim 1, wherein prior to indicating his or her feelings each participant has had the opportunity to communicate with the other participants via one or more of the following: online chat, online forums, text messaging over a network, video conferencing, telephone conferencing, voice communication transmitted over the Internet, any electronic network.

5. The method of claim 1, wherein prior to indicating his or her feelings each participant has had the opportunity to communicate with the other participants in a physical space, rather than over an electronic network.

6. The method of claim 1, wherein the participants are identified to each other using one or more of the following: a pseudonym, a user name, a real name, an e-mail address, a social security number, a driver's license number, a telephone number, a name, a public key, a gender, an age, a geographic location, a description, a label, an image, an animation, audio, video.

7. The method of claim 1, wherein the group is notified about all the feelings indicated by the participants toward each other.

8. The method of claim 1, wherein the group is notified about only some of the feelings indicated by the participants toward each other.

9. The method of claim 1, wherein the step of receiving input from participants includes receiving input through one or more of the following: the World Wide Web, the Internet, an instant messaging system, e-mail, an interactive telephone system, software executing on an online service, a wireless network, software executing on another data processing system in a network.

10. The method of claim 1, wherein the notification step includes automatically communicating through one or more of the following: the World Wide Web, the Internet, an instant messaging system, e-mail, a telephone system, software executing on an online service, a wireless network, software executing on another data processing system in a network.

11. The method of claim 1, wherein the method is implemented for users of a specific geographic location.

12. The method of claim 1, wherein the method is implemented for users who belong to a specific institution.

13. The method of claim 1, wherein the method is implemented for users who are affiliated with a specific organization.

14. The method of claim 1, wherein two or more participants can communicate privately with each other during one or more steps of claim 1.

15. An apparatus that allows members of a group to discover how they feel about each other, comprising:
an input portion, configured to receive input from participants indicating their feelings toward each other;
a determining portion, coupled to the input portion, configured to determine which of said participants indicated mutual feelings toward each other;
a first noticing portion, coupled to the determining portion, configured to notify the group about which of said participants indicated mutual feelings toward each other;
a second notifying portion, coupled to the determining portion, configured to notify the group about non-mutual feelings indicated by said participants toward other said participants;
an identity-concealing portion, coupled to the input portion and the notifying portions, configured to allow said participants to indicate said feelings toward each other and receive notification about said feelings without revealing their true identities to each other.

16. An apparatus that allows members of a group to discover how they feel about each other, comprising:
means for receiving input from participants indicating their feelings toward each other;
means for determining which of said participants indicated mutual feelings toward each other;
means for notifying the group about which of said participants indicated mutual feelings toward each other;
means for noticing the group about non-mutual feelings indicated by said participants toward other said participants;
means for allowing said participants to indicate said feelings toward each other and receive notification about said feelings without revealing their true identities to each other.

17. A computer program product, comprising:
a computer usable medium having computer readable code embodied therein for allowing members of a group to discover how they feel about each other, including:
computer readable program code devices configured to cause a computer to effect receiving input from participants indicating their feelings toward each other;
computer readable program code devices configured to cause a computer to effect determining which of said participants indicated mutual feelings toward each other;
computer readable program code devices configured to cause a computer to effect notifying the group about which of said participants indicated mutual feelings toward each other;
computer readable program code devices configured to cause a computer to effect notifying the group about non-mutual feelings indicated by said participants toward other said participants;
computer readable program code devices configured to cause a computer to effect allowing said participants to indicate said feelings toward each other and receive notification about said feelings without revealing their true identities to each other.
